(19) United States
(12) Patent Application Publication
(10) Pub. No.: US 2013/0199424 A1
(43) Pub. Date: Aug. 8, 2013

(54) DEVICE AND METHOD FOR PRODUCING A FINE-GRAINED FUEL BY DRYING AND IMPACT CRUSHING

(71) Applicants: Ralf Abraham, Bergkamen (DE); Stefan Hamel, Wenden (DE); Ralf Schäfer, Ruessingen/Pfalz (DE)

(72) Inventors: Ralf Abraham, Bergkamen (DE); Stefan Hamel, Wenden (DE); Ralf Schäfer, Ruessingen/Pfalz (DE)

(73) Assignees: PROACTOR SCHUTZRECHTSVERWALTUNGS GMBH, Ruessingen (DE); THYSSENKRUPP UHDE GMBH, Dortmund (DE)

(21) Appl. No.: 13/577,306

(22) PCT Filed: Jan. 26, 2011
(86) PCT No.: PCT/EP2011/000336

§ 371 Date: Oct. 15, 2012

(30) Foreign Application Priority Data
Feb. 4, 2010 (DE) 10 2010 006 916.7

(51) Int. Cl. F23G 5/033; F23G 5/04; F23G 5/46; B02C 13/288

(52) U.S. Cl. CPC F23G 5/033; B02C 13/288; F23G 5/04; F23G 5/46
USPC 110/205; 241/57; 241/18; 110/224; 110/222

(57) ABSTRACT

A device and method for producing a fine-grained fuel, in particular from solid, paste-like or aqueous energy feed stocks, by drying and crushing, including an impact reactor having a rotor and impact elements, a labyrinth seal in the region of the rotor shaft of the impact reactor, a device for feeding hot drying gas through the labyrinth seal into the impact reactor and at least one further feed device for hot drying gas in the bottom region of the impact reactor, a feed device for solid or paste-like energy feed stocks in the top region of the impact reactor, at least one extractor device for a gas flow containing crushed and dried energy feedstock particles, and a device for separating and extracting crushed and dried energy feed stock particles from the gas flow extracted from the impact reactor.

The invention relates to the thermal and mechanical pre-treatment in an impact reactor of materials, which may also be of a pasty or viscous consistency and which are referred to in the following as solid or pasty energy feedstocks, and include, for example, biogenous and other highly reactive fuels, fossil fuels and residues. Pasty refers to all materials which contain a mixture of solids and liquid components, examples being sewage sludges and industrial residues that are either aqueous based or based on solvents or energy-containing liquids, such as oleaginous substances or lubricants.

There has been a universal drive towards developing the use of regenerative energy sources and recycling waste and residues, with particular focus on the use for energy or materials. Co-combustion in existing combustion plants or mono-combustion in plants intended and designed specifically for that purpose, for example, are suited for the energy recovery of the abovementioned feedstocks. By contrast material use is achieved by means of thermal gasification. The synthesis gas produced in this way represents the feedstock for downstream chemical synthesis processes, such as for example, Fischer-Tropsch, methanol or ammonia synthesis.

With both the combustion technology and the gasification technology the specific costs involved mean that plant capacities have to be as large as possible. This means that entrained-flow processes are used most often. A characteristic of the entrained-flow process is that the fuels have to be crushed to yield a particle size which can be conveyed pneumatically to allow dust burners to be operated. Typical particle sizes for coal, for example, are in the <100 micrometre range.

The size of the particles for other fuels, such as reactive biomasses, can be considerably larger dependent upon the process parameters; reducing their moisture content is also advantageous. In the case of energy feedstocks such as biomasses, biogenous residues and waste, such pre-treatment based on conventional prior art is energy and equipment intensive due to the often tough, fibrous structure.

For example, the prior art pertaining to biomass drying is described in Kaltschmitt et al.: “Energie aus Biomasse”, ISBN 978-3-540-85094-6, 2009, pages 814 ff. Alongside the classic natural drying and aeration methods, the feed-and-turn dryers, belt dryers and rotary dryers are listed as technical drying devices in which the goods to be dried are conveyed. In none of the said devices are the particles crushed.

A range of processes which can execute drying and crushing simultaneously is also known from the field of coal processing, and also from mineral processing. These include, among others, vertical roller mills, beater wheel mills, ball mills. However, it is known that using these combined mill drying systems to crush biomasses is only conditionally possible, or not at all possible, on account of the fibrous and tough structure, and, according to current empirical evidence, they do not in any way produce a powdery product as would be required. Instead, cutting mills or hammer mills, for example, must be used. The former class of cutting mills require sharp cutting tools and a corresponding small fissure to facilitate a cutting process. This means that there is an extremely high degree of wear and, at the same time, a high susceptibility to impurities. The second class of hammer mills is characterised by a comparatively high degree of effort required for the mechanical crushing.

Therefore, the objective of the invention is to provide a contrivance technically simplified in terms of equipment and an energy-saving process that allows drying and crushing to be carried out in a single vessel, with the solid or pasty energy feedstocks being sufficiently pretreated to allow them to undergo entrained-flow gasification without the need for further steps.

The invention achieves this objective via a contrivance for the production of a fine-grained fuel, in particular from solid, pasty or aqueous energy feedstocks by means of drying and crushing, comprising
an impact reactor with a rotor and impact elements,
a labyrinth seal near the rotor shaft of the impact reactor,
a feed device for hot drying gas passing through the labyrinth seal into the impact reactor,
at least one additional hot drying gas feed device at the bottom of the impact reactor,
a feed device for solid or pasty energy feedstocks at the top of the impact reactor,
at least one device for discharging a gas stream containing crushed, dried energy feedstock particles, and
a device for separating and discharging crushed, dried energy feedstock particles from the gas stream discharged from the impact reactor.

The invention is characterised in that narrow fissures and cutting elements are not necessary, the crushing process having hardly any impact on material wear.

Further embodiments of the contrivance envisage that different fractions with differing particle sizes can be discharged from the impact reactor, in which deflector wheel classifiers or side screens, or both, are used as the discharge device for crushed and dried energy feedstock particles. In this way different grain fractions can be separated by means of different arrangements and mesh sizes.

Further embodiments of the contrivance pertain to the hot drying gas feed device at the bottom of the impact reactor whereby large quantities of drying gas are to be introduced. For this purpose bores are envisaged which are distributed over the circumference. It can also be envisaged that the bores be inclined in a radial direction and that the bores are oriented tangential to the circumferential direction of the impact elements. In so doing the outlet direction of the bores can be oriented with or against the direction of rotation of the rotor of the impact reactor. The most effective solution from a process engineering point of view is dependent upon the interaction of the properties of the material to be crushed, and the geometric arrangements of the rotor, and the impact elements, and the operational mode of the rotor, meaning for example the revolutions per minute, and the resulting impact on the flow processes.

Alternatively hot drying gas can be added at the bottom of the impact reactor by means of slit-shaped holes distributed across the circumference. In so doing the slits can also have a radial incline. The slits can also be formed by means of an overlapping assembly of base plates.

A further embodiment of the contrivance envisages a closed-loop configuration with a gas loop, additionally comprising
at least one supplementary firing device,
at least one pressurisation device in the closed-loop gas stream,
at least one device for feeding diluent gas into the closed-loop gas stream,
at least one device for coupling the waste heat obtained from the flue gas of the supplementary firing device into the closed-loop gas stream.

The objective of the invention is also achieved by means of a process for the production of a fine-grained fuel from solid, pasty or aqueous energy feedstocks by means of drying and impact crushing using an impact reactor with a rotor and impact elements,
the energy feedstocks being fed into the impact reactor at the top of the impact reactor,
hot drying gas being fed into the bottom of the impact reactor as well as via a labyrinth seal near the rotor shaft of the impact reactor,
the energy feedstocks being crushed and dried in the impact reactor, and
crushed and dried energy feedstock particles contained in a gas stream from the impact reactor being directed to a particle separator.

Further embodiments of the process according to the invention are induced in that the conveying of the solid or pasty energy feedstocks by conventional means can be cost-intensive if the feedstocks have a tendency to stick. Further embodiments therefore envisage that at least part of the drying gas, together with the energy feedstocks, is fed into the reactor by means of its feed device. It is important that the drying gas is sufficiently cool when it is introduced into the feed device. Introducing the drying gas causes the outer surface of the energy feedstocks to dry, particularly in the case of solid energy feedstocks, which leads to improved conveyability and considerably reduces the propensity to stick. The drying gas can be conveyed both in the countercurrent and the co-current flow.

One embodiment of the process envisages that the feed device be heated indirectly. As a result of the drying effect the drying gas cools as it passes through the feed device. The heating counteracts this cooling effect. The hot drying gas can also be used for heating, which in so doing cools itself, and is then fed through the feed device.

The drying gas can be fed unhindered into the impact reactor via a screw conveyor which is open to the impact reactor. In so doing it is advantageous if the energy feedstocks and the drying gas are fed through the screw conveyor in the co-current flow. A star-wheel feeder, which connects the silo to the screw conveyor, can prevent a backflow into the silo.

All feed methods for drying gas can also be used additively. It is, therefore, possible to introduce drying gas into the impact reactor via the labyrinth seal, via the energy feedstocks feed device, and via bores and slits in the bottom of the impact reactor allowing, from a process point of view, a reaction to the most varied feedstocks which is an advantage of the invention.

DE 196 00 482 A1 describes, for example, a suitable impact reactor. Surprisingly, this vessel is able to treat biomass, such as straw or green waste, in the same way it does the plastic fractions described. In order to improve effectiveness, it may also be expedient to use devices, such as those described in patent application DE 10 2005 055 620 A1.

The fact that drying and crushing take place at the same time in the present invention creates synergy effects from which both processes benefit. Due to the simultaneous treatment in the invention, rapid surface drying occurs when the coarse particles have been fed in and due to further heating of the particles a drying from the outside to the inside also occurs from the outside of the particle to the inside. Whereas in familiar prior art processes the size of the particle remains the same during drying (e.g. drum driers or belt driers for biomasses) in this case crushing takes place at the same time due to the impact effect, with the outer particle layers that have already been partly dried preferably being knocked off on contact with the impact elements. The remaining particle core that has not yet been fully dried is thus re-exposed and with a concomitant reduced size again subjected to the full heat transfer.

The overall drying time is reduced considerably by means of continuous crushing and simultaneous heating. On the one hand, the invention considerably reduces the demand for technical equipment of the conventional treatment chain and at the same time also reduces the specific lead time required.

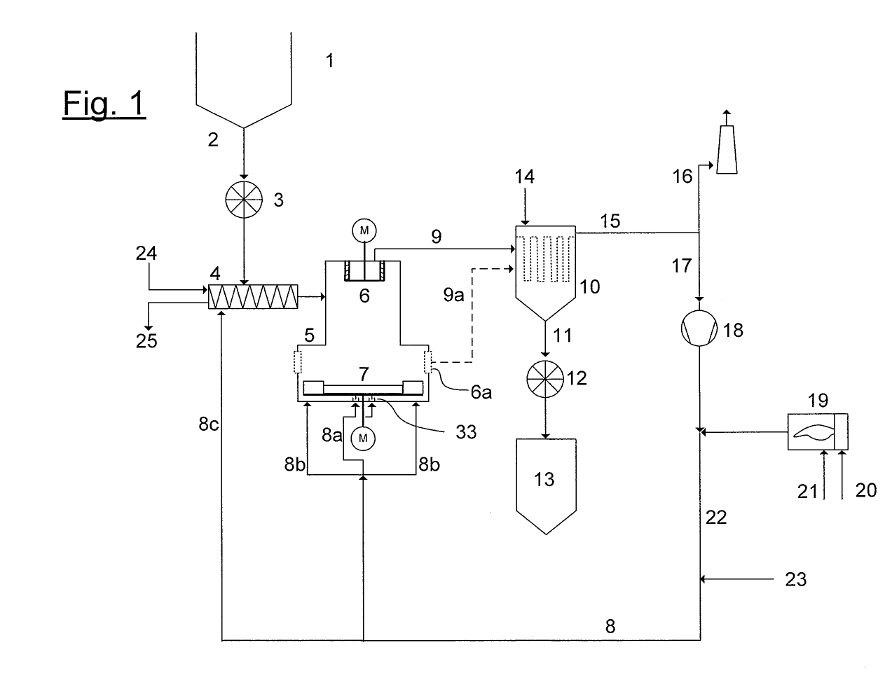

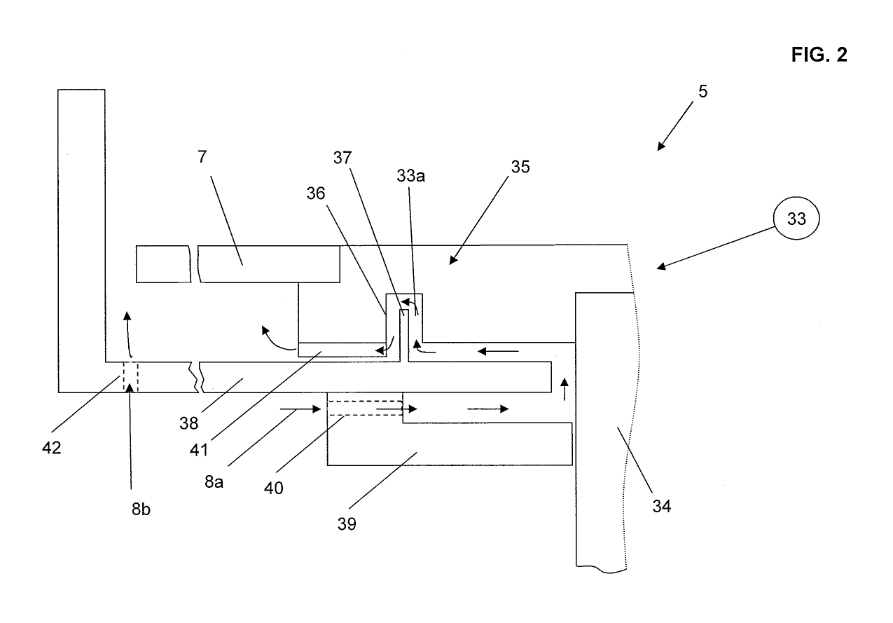

The invention is explained in greater detail below by means of an example in FIG. 1 and FIG. 2.

FIG. 1 shows the contrivance within a closed-loop operation;

FIG. 2 shows a detail section of the area of the rotor shaft of the impact reactor.

The biomass 2 is conveyed from the feed tank 1 into the impact reactor 5 via the star-wheel feeder 3 and the screw conveyor 4. Here, it is crushed by means of the rotor 7. At the bottom of the impact reactor 5 drying gas 8a is added via a labyrinth seal and drying gas 8b is added via holes in the bottom. The crushed and dried particles 11 are discharged from the impact reactor 5 with the gas stream 9 via a classifier 6—preferably a motor-driven rotary classifier—and directed to the particle separator 10, shown here as a filtering separators. Further discharge also occurs through the side outlet 6a, the discharged gas 9a also being conveyed to the particle separator 10.

An advantage here is that the use of the classifier 6 allows the size of the particles being discharged with the gas stream 9 to be adjusted. It may also be advantageous to dispense with the motor-driven rotary classifier and use screens or perforated plates which allow the size of the solids particles contained in the gas stream 9 to be controlled.

Depending on the desired use of the pretreated fuel, the target particle size of the dried particles 11 is defined by different requirements of the gasification or combustion plant. These are, for instance, requirements regarding the interaction of reactivity and particle size, the flow characteristics, and so forth, so different particle sizes or particle size distributions may be advantageous for different feedstocks. Therefore, different methods of pre-separation, such as classifiers or screens, are also feasible. Depending on the desired particle size, it may also be feasible to use either an inertial separator or a cyclone separator as the particle separator 10.

In the particle separator 10 the dried particles 11 are separated out and discharged by means of the star-wheel feeder 12 into the feed tank 13. The particle separator 10 is dedusted preferably by means of nitrogen 14. Depending on the integration of the present invention in further process steps, dedusting can occur using other inert gases or with carbon dioxide, air or with oxygen-depleted air.

The recycle gas 15, which is obtained from the particle separator 10, is clean and contains only small quantities of dust and can be discharged to the chimney 16. A part stream 17 is branched off beforehand and mixed with hot gas by means of the fan 18, the hot gas being obtained from air 20, and fuel gas 21 from the firing device 19. The drying gas 22 offset with diluent gas 23 is recycled back to the impact reactor 5.

There it is split and directed as drying gas 8a via a labyrinth seal, and as drying gas 8b via holes in the bottom of the impact reactor 5 as described above, and also as drying gas 8c into the screw conveyor 4 through which it also arrives at the impact reactor 5. In so doing, the screw conveyor 4 is indirectly heated by means of a thermal fluid with a thermal fluid return line 24 and a thermal fluid inlet 25.

Furthermore, FIG. 2 shows a detailed view of the part of the impact reactor 5 near the rotor shaft 34, via which the rotor 7 is driven by a motor that is not shown. As can be seen from FIG. 2, at the top end of the rotor shaft 34 there is a rotor connection 35, with an annular channel or groove 36 inserted into the bottom which has, for example, a rectangular cross-section. An annular projection 37, which is preferably positioned on the base plate 38 of the impact reactor 5, extends into the annular channel 36 from the bottom up. The projection 37 has a width that is smaller than the width of the channel 36 and its top does not extend fully to the bottom of the channel, thus creating a labyrinth seal 33 with a labyrinth passage 33a between the outer surface of the projection 37 and the inner surface of the channel 36, through which the complete amount of the drying gas (8a+8b) or a partial amount (8a), or other gas is introduced into the inside of the impact reactor 5. The labyrinth passage may, for example, have a width in the range of 2 mm to 20 mm. In accordance with an embodiment of the invention not shown, in order to improve the seal effect, the labyrinth seal 33 may also have, in a radial direction, two or more projections 37 which extend into appurtenant channels 36 shaped to match the shape of the projections.

The drying gas 8a fed via the labyrinth seal 33 is preferably fed along the feed route indicated by the arrows 8a through one or more holes 40 arranged in the shaft arrangement 39 underneath the base plate 38. This route first runs in the direction of the rotor shaft 34, i.e. the centre of rotation of the rotor 7, then essentially in an upwards direction parallel to the rotor shaft or rotation axis of the rotor 7 and subsequently above the base plate 38 back in the opposite direction radially outwards away from the centre of rotation of the impact reactor 5 through the labyrinth passage 33a, which results in particularly efficient sealing and distribution of the drying gas inside the reactor. This can also be further improved by using one or more impact slats 41 downstream of the labyrinth passage 33a in terms of flow.

The additional drying gas 8b is fed through one or more holes 42 located in the base plate 38. These holes 42 can be executed as several holes across the circumference or as one or more slits. It is also conceivable to envisage inclined bores to allow the gas 8b an advantageous direction of flow, from a process point of view, when flowing into the impact reactor 5.

### LIST OF REFERENCE NUMBERS AND DESIGNATIONS

1 Feed tank
2 Biomass
3 Star-wheel feeder
4 Screw conveyor
5 Impact reactor
6 Classifier
6a Side outlet
7 Rotor
8 8, 8a, 8b, 8c hot recycle gas/drying gas
9 Gas stream through classifier
9a Gas stream through side outlet
10 Particle separator
11 Dried particles
12 Star-wheel feeder
13 Feed tank
14 Back purge gas
15 Dedusted gas
16 Waste gas
17 Recycle gas
18 Fan
19 Burner
20 Air
21 Fuel gas
22 Gas
23 Diluent gas
24 Thermal fluid for screw conveyor
25 Thermal fluid return line
33 Labyrinth seal
33a Labyrinth passage
35 Rotor connection
34 Rotor shaft
36 Channel
37 Projection
38 Base plate
39 Shaft arrangement
40 Hole
41 Impact slat
42 Hole
M Motor

1. A device for the production of a fine-grained fuel, in particular from solid, pasty or aqueous energy feedstocks by means of drying and crushing, comprising
an impact reactor with a rotor and impact elements,
a labyrinth seal near the rotor shaft of the impact reactor,
a device for feeding hot drying gas through the labyrinth seal into the impact reactor,
at least one additional hot drying gas feed device in the bottom of the impact reactor,
one solid or pasty energy feedstock feed device at the top of the impact reactor,
at least one device for discharging a gas stream containing crushed and dried energy feedstock particles, and
a device for separating and discharging crushed and dried energy feedstock particles from the gas stream discharged from the impact reactor.

2. The device according to claim 1, wherein deflector wheel classifiers are envisaged as the discharge device for crushed and dried energy feedstock particles.

3. The device according to claim 1, wherein side screens are envisaged as the discharge device for crushed and dried energy feedstock particles.

4. The device according to claim 1, wherein holes distributed across the circumference are envisaged as the hot drying gas feed device at the bottom of the impact reactor.

5. The device according to claim 4, wherein the holes are inclined in a radial direction.

6. The device according to claim 5, wherein the holes are oriented tangential to the circumferential direction of the impact elements.

7. The device according to claim 1, wherein slit-shaped holes distributed across the circumference are envisaged as the hot drying gas feed device in the bottom of the impact reactor.

8. The device according to claim 7, wherein the slits have a radial incline.

9. The device according to claim 7, wherein the slits are formed by means of an overlapping assembly of base plates.

10. The device according to claim 1, wherein the device comprises a closed-loop configuration with a gas loop, also comprising
at least one supplementary firing device,
at least one pressurisation device in the closed-loop gas stream,
at least one device for feeding diluent gas into the closed-loop gas stream,
at least one device for coupling the waste heat obtained from the flue gas of the supplementary firing device into the closed-loop gas stream.

11. A method for the production of a fine-grained fuel from solid, pasty or aqueous energy feedstocks through drying and impact crushing using an impact reactor with a rotor and impact elements according to claim 1,
said energy feedstocks being fed into the impact reactor at the top of said impact reactor,
hot drying gas being added at the bottom of the impact reactor as well as via a labyrinth seal near the rotor shaft of the impact reactor,
the energy feedstocks being crushed and dried in the impact reactor, and
crushed and dried energy feedstock particles contained in a gas stream from the impact reactor being directed to a particle separator.

12. The method according to claim 11, wherein at least a part of the drying gas is fed into the reactor by means of its feed device together with the energy feedstocks.

13. The method according to claim 12, wherein the device for feeding the energy feedstock into the reactor is indirectly heated.

14. The method according to claims 11 to 13, wherein a closed-loop operation is envisaged, with
at least one supplementary firing device, the energy from the flue gas obtained being used directly or indirectly to heat the closed-loop gas stream,
a diluent gas being fed to the closed-loop gas stream, the gas being an inert gas such as nitrogen or carbon dioxide, or a gas with reduced oxygen content, or air, or a mixture of the said gases.
the pressure loss in the closed-loop gas stream being compensated, and
the heated closed-loop gas stream being recycled back to the impact reactor.
